(19) United States
(12) Patent Application Publication
(10) Pub. No.: US 2019/0297525 A1
(43) Pub. Date: Sep. 26, 2019

(54) ADAPTIVE NAN DISCOVERY BEACON TRANSMISSION INTERVAL CHANGES

(71) Applicant: QUALCOMM Incorporated, San Diego, CA (US)

(72) Inventors: Sumanth KERAGODU SURYA PRAKASH, San Jose, CA (US); Alireza RAISSINIA, Monte Sereno, CA (US); Sandip HOMCHAUDHURI, San Jose, CA (US); Anuradha CHANDRAMOULI, San Jose, CA (US)

(21) Appl. No.: 15/926,744

(22) Filed: Mar. 20, 2018

(51) Int. Cl. H04W 28/02; H04W 24/08; H04W 28/12; H04W 48/16

(52) U.S. Cl. CPC H04W 28/0284; H04W 24/08; H04W 48/16; H04W 28/12; H04W 28/0289

(57) ABSTRACT

This disclosure provides systems, devices, apparatus and methods, including computer programs encoded on storage media, for wireless communications. In one aspect, a method for wireless communications may include monitoring, at a wireless device, a congestion of a channel; adapting, at the wireless device, an interval at which discovery beacons are transmitted based on the congestion of the channel; and transmitting from the wireless device the discovery beacons on the channel at the adapted interval.

### TECHNICAL FIELD

This disclosure relates generally to wireless communications, and more specifically, to neighbor aware network (NAN) discovery beacon transmission intervals.

### DESCRIPTION OF THE RELATED TECHNOLOGY

Advances in technology have resulted in smaller and more powerful computing devices. For example, there currently exists a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Electronic devices, such as wireless telephones, may use wireless connections to access networks in order to transmit and receive data. In addition, electronic devices may use wireless connections to exchange information directly with each other. For example, mobile electronic devices that are in close proximity to each other may use a neighbor aware network (NAN) to perform data exchanges via the NAN (e.g., without involving wireless carriers, wireless fidelity (Wi-Fi) access points, and/or the Internet). To join a NAN, a device performs a scan for a “discovery beacon” for a time interval designated by a NAN standard. In order to ensure reception of discovery beacons, the device activates a receiver for an entirety of the time interval, thus consuming power during the entirety of the time interval.

If the device receives a discovery beacon, the device may use the discovery beacon to determine a time of an upcoming “discovery window” during which the device may perform one or more operations to join the NAN. Discovery beacons may be transmitted during the time interval preceding the “discovery window.” A “master” device periodically transmits the discovery beacons at regular intervals without taking channel conditions into consideration. Blind transmission of discovery beacons may lead to inefficient discoverability of the master device, as well as unnecessary power consumption of both the master device and the device scanning for the discovery beacons.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications. In some implementations, the method includes monitoring, at a wireless device, a congestion of a channel; adapting, at the wireless device, an interval at which discovery beacons are transmitted based on the congestion of the channel; and transmitting from the wireless device the discovery beacons on the channel at the adapted interval.

In some implementations, the method can include decreasing the interval at which the discovery beacons are transmitted if the channel is congested. In some implementations, the method can include increasing the interval at which the discovery beacons are transmitted if the channel is uncongested. In some implementations, the method can include collecting at least one channel congestion metric.

In some implementations, the method can include determining a congestion score based on the at least one channel congestion metric. In some implementations, the congestion score is proportional to an amount of congestion on the channel. In some implementations, the method can include transmitting the discovery beacons at a first discovery beacon transmission interval if the congestion score is above a predetermined threshold.

In some implementations, the method can include transmitting the discovery beacons at a second discovery beacon transmission interval if the congestion score is below the predetermined threshold, the second discovery beacon transmission interval being greater than the first discovery beacon transmission interval. In some implementations, the first discovery beacon transmission interval is less than a default discovery beacon transmission interval, and the second discovery beacon transmission interval is greater than the default discovery beacon transmission interval.

In some implementations, the first discovery beacon transmission interval is proximate a lower bound of a range for discovery beacon transmission provided by a Wi-Fi Neighbor Aware Network (NAN) Technical Specification. In some implementations, the second discovery beacon transmission interval is proximate an upper bound of the range for discovery beacon transmission provided by the Wi-Fi NAN Technical Specification.

In some implementations, the method can include transmitting the discovery beacons at the default discovery beacon transmission interval until the at least one channel congestion metric is collected. In some implementations, the method can include collecting data for the at least one channel congestion metric over a plurality of time periods to build a database. In some implementations, the method can include using the database to determine the interval at which the discovery beacons are transmitted.

Another innovative aspect of the subject matter described in this disclosure can be implemented in a wireless device. In some implementations, the wireless device can include a transceiver; a memory; and a processor communicatively coupled to the transceiver and the memory, the processor configured to: monitor a congestion of a channel, adapt an interval at which discovery beacons are transmitted based on the congestion of the channel, and transmit, via the transceiver, the discovery beacons on the channel at the adapted interval.

In some implementations, the processor is further configured to decrease the interval at which the discovery beacons are transmitted if the channel is congested. In some implementations, the processor is further configured to increase the interval at which the discovery beacons are transmitted if the channel is uncongested.

In some implementations, the processor is further configured to collect at least one channel congestion metric. In some implementations, the processor is further configured to determine a congestion score based on the at least one channel congestion metric. In some implementations, the congestion score is proportional to an amount of congestion on the channel.

In some implementations, the processor is further configured to transmit the discovery beacons at a first discovery beacon transmission interval if the congestion score is above a predetermined threshold. In some implementations, the processor is further configured to transmit the discovery beacons at a second discovery beacon transmission interval if the congestion score is below the predetermined threshold, the second discovery beacon transmission interval being greater than the first discovery beacon transmission interval.

In some implementations, the first discovery beacon transmission interval is less than a default discovery beacon transmission interval, and the second discovery beacon transmission interval is greater than the default discovery beacon transmission interval. In some implementations, first discovery beacon transmission interval is proximate a lower bound of a range for discovery beacon transmission provided by a Wi-Fi Neighbor Aware Network (NAN) Technical Specification.

In some implementations, the second discovery beacon transmission interval is proximate an upper bound of the range for discovery beacon transmission provided by the Wi-Fi NAN Technical Specification. In some implementations, the processor is further configured to transmit the discovery beacons at the default discovery beacon transmission interval until the at least one channel congestion metric is collected.

In some implementations, the processor is further configured to collect data for the at least one channel congestion metric over a plurality of time periods to build a database. In some implementations, the processor is further configured to use the database to determine the interval at which the discovery beacons are transmitted.

Another innovative aspect of the subject matter described in this disclosure can be implemented in an apparatus for wireless communication. In some implementations, the apparatus includes means for monitoring a congestion of a channel; means for adapting an interval at which discovery beacons are transmitted based on the congestion of the channel; and means for transmitting the discovery beacons on the channel at the adapted interval.

Another innovative aspect of the subject matter described in this disclosure can be implemented in a non-transitory computer-readable storage medium storing instructions that, when executed by one or more processors of a wireless communications device, cause the wireless communications device to monitor a congestion of a channel, adapt an interval at which discovery beacons are transmitted based on the congestion of the channel, and transmit the discovery beacons on the channel at the adapted interval.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example wireless communication system in which aspects of the present disclosure may be employed.

FIG. 2 shows another example wireless communication system in which aspects of the present disclosure may be employed.

FIG. 3 shows another example wireless communication system in which aspects of the present disclosure may be employed.

FIG. 4 shows another example wireless communication system in which aspects of the present disclosure may be employed.

FIG. 5 illustrates a functional block diagram of a wireless device that may be employed within the wireless communication systems of FIGS. 1-4.

FIG. 6 illustrates an example timing diagram for NAN discovery beacon transmissions in accordance with various aspects of the present disclosure.

FIG. 7 illustrates an example timing diagram for NAN discovery beacon transmissions on a congested channel in accordance with various aspects of the present disclosure.

FIG. 8 illustrates an example timing diagram for NAN discovery beacon transmissions on an uncongested channel in accordance with various aspects of the present disclosure.

FIG. 9 is a flowchart illustrating an example of a method for wireless communications in accordance with various aspects of the present disclosure.

FIG. 10 is a flowchart illustrating another example of a method for wireless communications in accordance with various aspects of the present disclosure.

Like reference numerals refer to corresponding parts throughout the drawing figures.

### DETAILED DESCRIPTION

Described examples are directed to methods, devices, and apparatuses for wireless communications in which neighbor aware network (NAN) discovery beacon transmission intervals may be adapted. According to some aspects, a master device of a NAN may dwell on a channel for a finite duration and collect channel congestion metrics. The channel congestion metrics may be used to dynamically change an interval at which discovery beacons are transmitted. If the channel is congested, a scanning device may not reliably receive the discovery beacons due to interference and collision. Therefore, the master device may transmit discovery beacons more aggressively at a shortened interval in order to improve discoverability. If the channel is not congested, the master device may transmit discovery beacons less aggressively at an increased interval in order to reduce power consumption.

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure may, however, be embodied in many different forms and may not be construed as limited to any specific structure or function presented throughout this disclosure. Rather, these aspects are provided so that this disclosure may be thorough and complete, and may fully convey the scope of the disclosure to those skilled in the art. The scope of the disclosure covers any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention covers such an apparatus or method which is practiced using other structure, functionality, or structure and functionality in addition to or other than the various aspects of the invention set forth herein. Any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not limited to particular benefits, uses, or objectives. Rather, aspects of the disclosure are broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some implementations, a WLAN includes various devices which are the components that access the wireless network. For example, there may be two types of devices: access points (“APs”) and clients (also referred to as stations, or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a WiFi (e.g., IEEE 802.11 protocol) compliant wireless link to obtain general connectivity to the Internet or to other wide area networks. In some implementations a STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device or wireless device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

Devices, such as a group of stations, for example, may be used for neighbor aware network (NAN), or social-WiFi networking. For example, various stations within the network may communicate on a device to device (e.g., peer-to-peer communications) basis with one another regarding applications that each of the stations supports. It is desirable for a discovery protocol used in a social-WiFi network to enable STAs to advertise themselves (e.g., by sending discovery packets) as well as discover services provided by other STAs (e.g., by sending paging or query packets), while ensuring secure communication and low power consumption. A discovery packet may also be referred to as a discovery message or a discovery frame. A paging or query packet may also be referred to as a paging or query message or a paging or query frame.

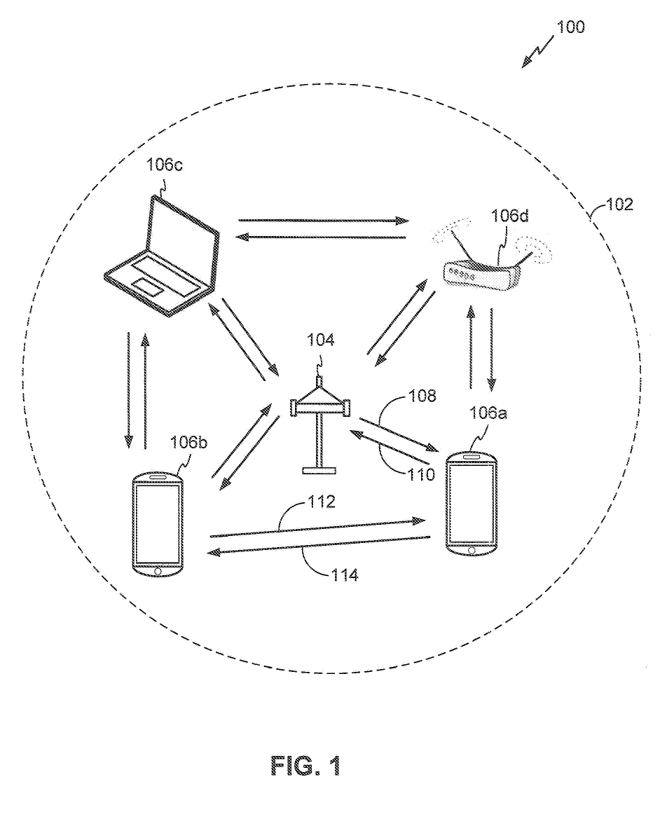

FIG. 1 illustrates an example of a wireless communication system 100 in which aspects of the present disclosure may be employed. The wireless communication system 100 may operate pursuant to a wireless standard, such as an 802.11 standard. The wireless communication system 100 may include an AP 104, which communicates with STAs 106. In some aspects, the wireless communication system 100 may include more than one AP. Additionally, the STAs 106 may communicate with other STAs 106. As an example, a first STA 106a may communicate with a second STA 106b. As another example, a first STA 106a may communicate with a third STA 106c although this communication link is not illustrated in FIG. 1.

A variety of processes and methods may be used for transmissions in the wireless communication system 100 between the AP 104 and the STAs 106 and between an individual STA, such as the first STA 106a, and another individual STA, such as the second STA 106b. For example, signals may be sent and received in accordance with OFDM/OFDMA techniques. If this is the case, the wireless communication system 100 may be referred to as an OFDM/OFDMA system.

Alternatively, signals may be sent and received between the AP 104 and the STAs 106 and between an individual STA, such as the first STA 106a, and another individual STA, such as the second STA 106b, in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

A communication link may be established between STAs, such as during social-WiFi networking. Some possible communication links between STAs are illustrated in FIG. 1. As an example, a communication link 112 may facilitate transmission from the first STA 106a to the second STA 106b. Another communication link 114 may facilitate transmission from the second STA 106b to the first STA 106a.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). An extended service set (ESS) is a set of connected BSSs. In another example, the wireless communication system 100 may not have a central AP 104, but rather may function as a peer-to-peer network between the STAs 106. Accordingly, the functions of the AP 104 described herein may alternatively be performed by one or more of the STAs 106.

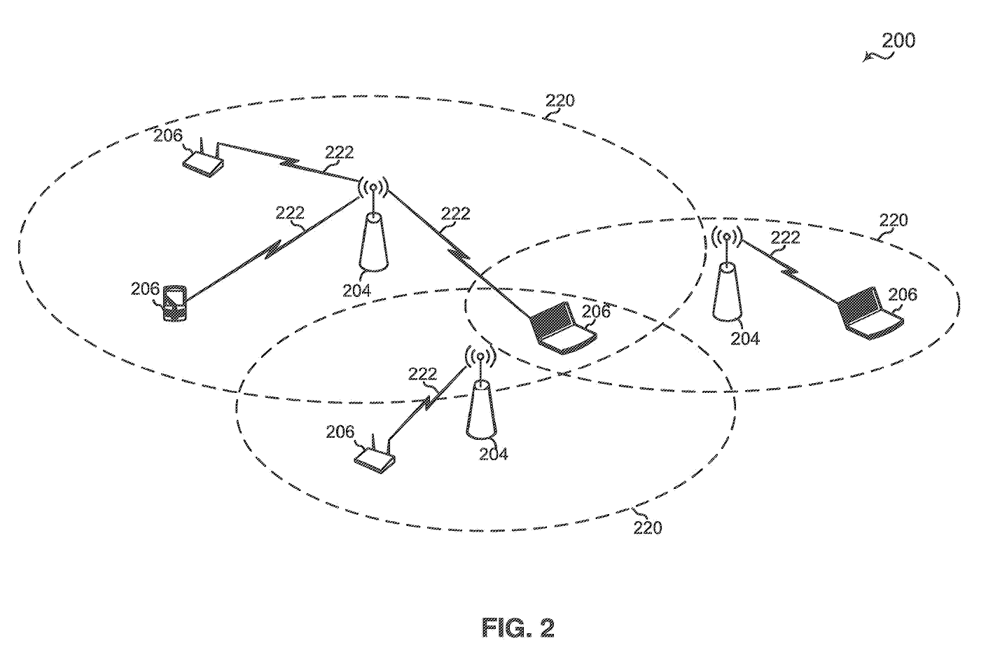

Referring to FIG. 2, a wireless communication system 200 may include one or more STAs 206 located in an intersection of more than one coverage area 220 and associated with more than one AP 204. Each AP 204 may generate a WLAN, such as an IEEE 802.11 network, with STAs 206. The STAs 206 may be distributed or deployed within a coverage area 220. Each STAs 206 may associate and communicate, via communication links 222, with one of the APs 204. Each AP 204 has a coverage area 220 such that STAs 206 within that area can typically communicate with the AP 204. A STA 206 can be covered by more than one AP 204 and may therefore associate with different APs at different times depending on which one provides a more suitable connection. The coverage areas 220 of the APs 204 may overlap. When nearby BSSs or APs have overlapping coverage areas, such BSSs may be referred to as overlapping BSSs or OBSSs. In dense deployments of WLANs, some APs may be automatically configured to work on the same channel, which may increase channel congestion.

In some instances, a subset of APs 204 or several of the STAs 206 may connect to each other to establish a NAN. A NAN may be established for network communications in a relatively small geographic area, for example. In some deployments, a NAN may provide communications directed to certain devices or to devices that may be running certain applications. The devices or applications may cause a STA 206 to seek to connect to the NAN. In some cases, several STAs 206 may form a NAN that does not include an AP 204, through the establishment of a peer-to-peer network. In this type of network or group, one of the STAs 206 may operate as the AP for the group and is typically referred to as the master. One of the STAs 206 may operate as an anchor master, and one or more other STAs 206 may operate as masters.

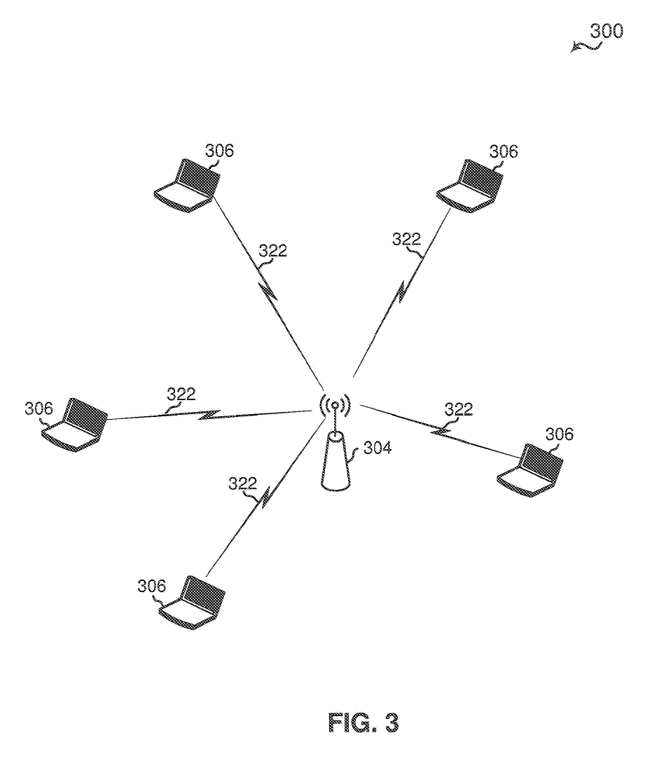

Referring to FIG. 3, a wireless communication system 300, which may be referred to as a NAN cluster, is shown. The NAN cluster 300 includes multiple STAs 306 configured in a NAN that communicate with an AP 304 using communication links 322. NAN information for connection with the AP 304 (or other NAN devices 306) may be periodically transmitted in a NAN discovery beacon from AP 304. AP 304 may transmit a NAN discovery beacon on a predefined channel in a radio frequency spectrum used by the wireless communication system 300. For example, the NAN network may operate on channel 6 (2.437 GHz) in the 2.4 GHz band and optionally in channel 44 (5.220 GHz) or channel 149 (5.745 GHz) of the 5 GHz band.

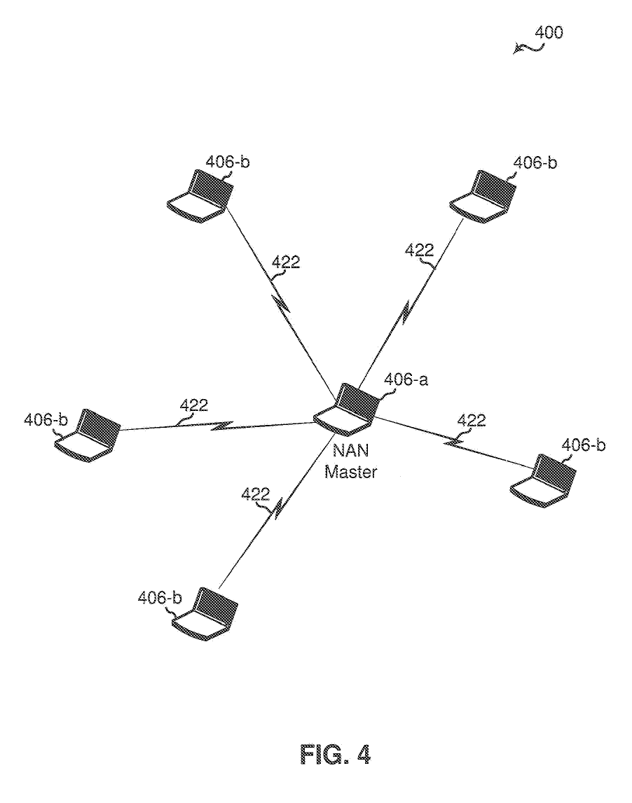

Referring to FIG. 4, another wireless communication system 400, which may be referred to as a NAN cluster is shown. The NAN cluster 400 includes multiple STAs 406 configured in a NAN that communicate with a NAN master 406-a using communication links 422. In this example, the NAN master 406-a may perform similar functions as described above with respect to AP 304 in FIG. 3. More specifically, the NAN master 406-a may periodically transmit a NAN discovery beacon, which includes NAN information for connection with the NAN master 406-a (or other NAN devices 406-b). The NAN master 406-a may transmit a NAN discovery beacon on a predefined channel in a radio frequency spectrum used by the wireless communication system 400, such as channel 6 (2.437 GHz) of the 2.4 GHz band, channel 44 (5.220 GHz) or channel 149 (5.745 GHz) of the 5 GHz band.

The other STAs or NAN devices 406-b may use an active scan to detect the NAN discovery beacons and connect to the NAN master 406-a and/or to each other. In some cases, such as on a congested channel, one or more STAs 306 may not reliably receive the discovery beacon transmissions. This may result in additional monitoring by the one or more STAs 306 to try to detect the discovery beacon. It is desirable to reduce the time period used for the additional monitoring in order to decrease power consumption.

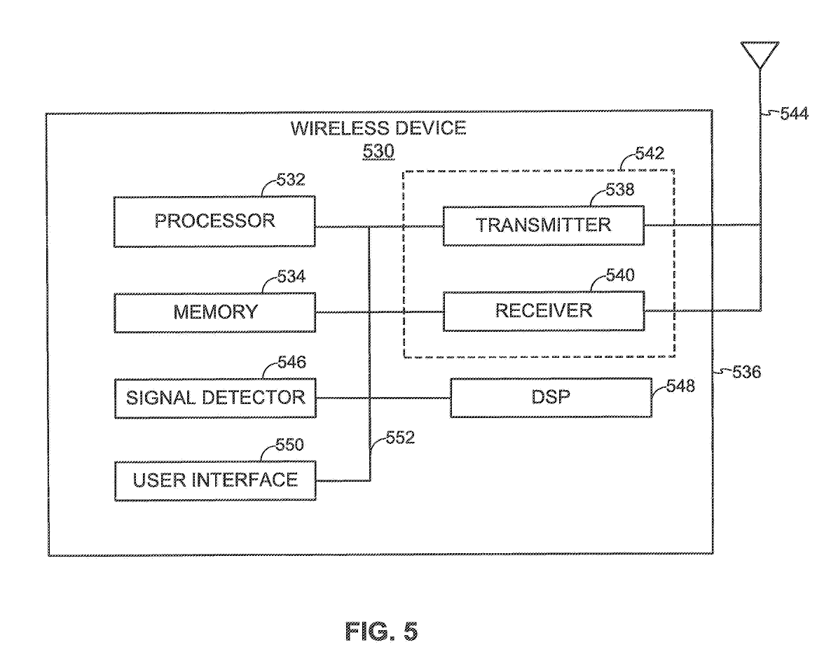

FIG. 5 illustrates various components that may be utilized in a wireless device 530 that may be employed within the wireless communication systems 100, 200, 300, 400. The wireless device 530 is an example of a device that may be configured to implement the various methods described herein. For example, the wireless device 530 may comprise one or more of the APs 104, 204, 304, and/or one or more of the STAs (or NAN devices) 106, 206, 306, 406.

The wireless device 530 may include a processor 532 which controls operation of the wireless device 530. The processor 532 may also be referred to as a central processing unit (CPU). Memory 534, which may include both read-only memory (ROM) and random access memory (RAM), may provide instructions and data to the processor 532. A portion of the memory 534 may also include non-volatile random access memory (NVRAM). The processor 532 may perform logical and arithmetic operations based on program instructions stored within the memory 534. The instructions in the memory 534 may be executable (by the processor 532, for example) to implement the methods described herein.

The processor 532 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 530 may also include a housing 536 that may include a transmitter 538 and/or a receiver 540 to allow transmission and reception of data between the wireless device 530 and a remote location. The transmitter 538 and receiver 540 may be combined into a transceiver 542. An antenna 544 may be attached to the housing 536 and electrically coupled to the transceiver 542. The wireless device 530 may also include (not shown) multiple transmitters, multiple receivers, multiple transceivers, and/or multiple antennas.

The transmitter 538 may be configured to wirelessly transmit packets having different packet types or functions. For example, the transmitter 538 may be configured to transmit packets of different types generated by the processor 532. When the wireless device 530 is implemented or used as an AP, STA, or NAN device, the processor 532 may be configured to process packets of a plurality of different packet types. For example, the processor 532 may be configured to determine the type of packet and to process the packet and/or fields of the packet accordingly. The processor 532 may also be configured to select and generate one of a plurality of packet types. For example, the processor 532 may be configured to generate a discovery packet comprising a discovery message and to determine what type of packet information to use in a particular instance.

The receiver 540 may be configured to wirelessly receive packets having different packet types. In some aspects, the receiver 540 may be configured to detect a type of a packet used and to process the packet accordingly.

The wireless device 530 may also include a signal detector 546 that may be used in an effort to detect and quantify the level of signals received by the transceiver 542. The signal detector 546 may detect such signals as total energy, energy per subcarrier per symbol, power spectral density and other signals. The wireless device 530 may also include a digital signal processor (DSP) 548 for use in processing signals. The DSP 548 may be configured to generate a packet for transmission. In some aspects, the packet may comprise a physical layer protocol data unit (PPDU).

The wireless device 530 may further comprise a user interface 550 in some aspects. The user interface 550 may comprise a keypad, a microphone, a speaker, and/or a display. The user interface 550 may include any element or component that conveys information to a user of the wireless device 530 and/or receives input from the user.

The various components of the wireless device 530 may be coupled together by a bus system 552. The bus system 552 may include a data bus, for example, as well as a power bus, a control signal bus, and a status signal bus in addition to the data bus. The components of the wireless device 530 may be coupled together to accept or provide inputs to each other using some other mechanism.

Although a number of separate components are illustrated in FIG. 5, one or more of the components may be combined or commonly implemented. For example, the processor 532 may be used to implement not only the functionality described above with respect to the processor 532, but also to implement the functionality described above with respect to the signal detector 546 and/or the DSP 548. Further, each of the components illustrated in FIG. 5 may be implemented using a plurality of separate elements. In addition, more components than that described and illustrated in FIG. 5 may be used to comprise the wireless device 530.

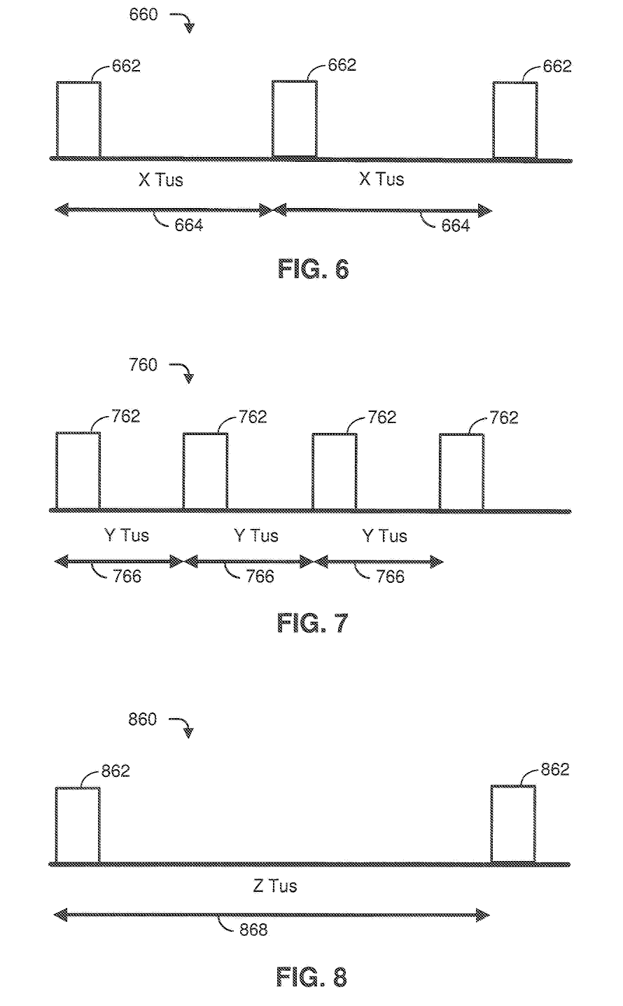

FIG. 6 illustrates, in an aspect, an example timing diagram 660 for NAN discovery beacon transmissions. As shown in the example timing diagram 660, NAN discovery beacons 662 may be transmitted at a default discovery beacon transmission interval 664. The default discovery beacon transmission interval 664 may comprise a predetermined time period at which the NAN discovery beacons 662 are transmitted based on a device implementation and/or an application specific implementation of the wireless device 530. The default discovery beacon transmission interval 664 may be preprogrammed into a memory associated with a processor of the wireless device, such as the memory 534 associated with the processor 532 of the wireless device 530.

In particular, the default discovery beacon transmission interval 664 may have a duration of X time units (Tus). The wireless device 530, such as the AP 304 or the NAN master 406-a, may periodically transmit a NAN discovery beacon 662 once every X Tus. The default discovery beacon transmission interval 664 may be within a range for discovery beacon transmission provided by the NAN Technical Specification. For instance, the range for discovery beacon transmission provided by the NAN Technical Specification may be 50 Tus to 200 Tus, with 50 Tus being a lower bound of the range and 200. Tus being an upper bound of the range. The range of 50 Tus to 200 Tus is for example purposes only, and other discovery beacon transmission ranges than that may be used. The processor 532 of the wireless device 530, such as the AP 304 or the NAN master 406-a, may be configured to transmit NAN discovery beacons at the default discovery beacon transmission interval 664 until channel congestion metrics are collected.

In another aspect, once channel congestion metrics are collected, the wireless device 530 may no longer transmit the NAN discovery beacons at the default discovery beacon transmission interval 664. More specifically, an interval at which the NAN discovery beacons are transmitted may be adapted based on the congestion of the channel. The processor 532 of the wireless device 530, such as the AP 304 or the NAN master 406-a, may be configured to dynamically change the discovery beacon transmission interval depending on the congestion level of the channel as indicated by the channel congestion metrics.

Thus, a frequency of the discovery beacon transmissions may be increased or decreased to account for the traffic conditions and congestion on the channel. Prior art wireless devices are configured to transmit discovery beacons solely at the default discovery beacon transmission interval. By providing the novel feature of an adaptive discovery beacon transmission interval as described herein, the discoverability of the wireless device 530, such as the AP 304 or the NAN master 406-a, may be improved and the power consumption of the wireless device 530 and the device(s) scanning for the discovery beacons may be decreased.

More specifically, the wireless device 530 may collect one or more channel congestion metrics to monitor traffic conditions and a congestion of the channel when NAN is enabled and the wireless device 530 assumes the role of a NAN master device. The channel congestion metrics may comprise measurements and statistics indicative of a level of congestion on the channel. The processor 532 of the wireless device 530 may be configured to dwell on the channel, such as channel 6 (2.437 GHz) of the 2.4 GHz band, channel 44 (5.220 GHz) or channel 149 (5.745 GHz) of the 5 GHz band, to collect the channel congestion metrics. In addition, the processor 532 may be configured to collect the channel congestion metrics for a finite predetermined time period. The predetermined time period may be preprogrammed into the memory 534 associated with the processor 532.

In an example, the channel congestion metrics may include but not be limited to: a congestion total on the Industrial, Scientific, and Medical (ISM) band, a Wi-Fi congestion total, an uplink Wi-Fi total, a downlink Wi-Fi total, a BSS traffic total, an OBSS traffic total, a transmissions total, and any combination thereof. For instance, the wireless device 530 may use energy detection to determine the congestion total on the ISM band. The Wi-Fi congestion total may include Wi-Fi packets transmitted from and received by the wireless device 530, as well as other Wi-Fi traffic on the channel. The Wi-Fi congestion total may be computed after detecting physical layer (PHY) preambles of the packets. The transceiver 542 of the wireless device 530 may detect the uplink Wi-Fi total, the downlink Wi-Fi total, the BSS traffic total, the OBSS traffic total, and the transmissions total. However, other channel congestion metrics and other ways to collect the channel congestion metrics may be used.

Furthermore, the processor 532 may be further configured to collect the channel congestion metrics each time the wireless device 530 dwells on the same channel for beacon transmission. Based on the data of the channel congestion metrics collected every beacon transmission period, the processor 532 may build a database of channel congestion metrics. The processor 532 may be further configured to use the database to determine the interval at which the NAN discovery beacons are transmitted. For instance, a duration of the discovery beacon transmission interval may be determined based on hysteresis built with the collection of data from one or more prior intervals.

In an aspect, the processor 532 of the wireless device 530, such as the AP 304 or the NAN master 406-a, may be further configured to compute how congested the channel is, or quantify the level of congestion on the channel, based on the channel congestion metrics. For example, a weighted formula may be preprogrammed into the memory 534 associated with the processor 532. The processor 532 may be configured to use the channel congestion metrics as inputs into the weighted formula in order to calculate a congestion score. In addition, the hysteresis built from the database of channel congestion metrics may be factored into the congestion score, such as via another input into the weighted formula. The congestion score may be directly proportional to an amount of congestion on the channel, and the processor 532 may be further configured to adapt the discovery beacon transmission interval based on the congestion score.

In another aspect, the processor 532 of the wireless device 530, such as the AP 304 or the NAN master 406-a, may be further configured to compare the congestion score to a predetermined threshold in order to determine whether the channel is congested or uncongested. The predetermined threshold may be preprogrammed into the memory 534 associated with the processor 532 and may be established via field testing and laboratory experimentation. If the congestion score is higher than the predetermined threshold, this may be indicative of a congested channel. If the congestion score is lower than the predetermined threshold, this may be indicative of an uncongested channel.

FIG. 7 illustrates, in an aspect, an example timing diagram 760 for NAN discovery beacon transmissions on a congested channel. If the channel is congested, scanning devices may not reliably receive the NAN discovery beacons due to interference and collision. Therefore, the processor 532 of the wireless device 530, such as the AP 304 or the NAN master 406-a, may be configured to decrease the interval at which the NAN discovery beacons are transmitted in a congested environment.

By decreasing the discovery beacon transmission interval, the frequency of the discovery beacon transmissions is increased. Increasing the frequency of the discovery beacon transmissions in a congested environment may provide the scanning devices with a higher probability of receiving the NAN discovery beacons. In so doing, the wireless device 530 may transmit the NAN discovery beacons more aggressively on the congested channel in order to improve its discoverability, as well as limit power consumption of the wireless device 530 and the scanning devices via quicker discovery.

As shown in the example timing diagram 760, NAN discovery beacons 762 may be transmitted at a first discovery beacon transmission interval 766 when the channel is congested. The first discovery beacon transmission interval 766 may be less than the default discovery beacon transmission interval 664 (FIG. 6). Being an aggressive interval, the first discovery beacon transmission interval 766 may have a duration of Y Tus, with Y<X (where X is the duration of the default discovery beacon transmission interval 664). The wireless device 530, such as the AP 304 or the NAN master 406-a, may periodically transmit a NAN discovery beacon 762 once every Y Tus.

The first discovery beacon transmission interval 766 may be preprogrammed into a memory associated with a processor of the wireless device, such as the memory 534 associated with the processor 532 of the wireless device 530. In addition, the first discovery beacon transmission interval 766 may be within the range for discovery beacon transmission provided by the NAN Technical Specification. For instance, the first discovery beacon transmission interval 766 may be proximate or equal to the lower bound of the range provided by the NAN Technical Specification. However, other configurations for the first discovery beacon transmission interval 766 may be used.

The processor 532 of the wireless device 530, such as the AP 304 or the NAN master 406-a, may be configured to transmit the NAN discovery beacons 762 at the first discovery beacon transmission interval 766 when the channel is congested. More specifically, the wireless device 530 may transmit the NAN discovery beacons 762 at the first discovery beacon transmission interval 766 if the congestion score is above the predetermined threshold. However, other configurations may be used to adapt the discovery beacon transmission interval in a congested environment. Moreover, the processor 532 of the wireless device 530 may be configured to continually collect the channel congestion metrics and continually adapt the discovery beacon transmission interval to the real-time channel congestion metrics and the real-time congestion on the channel.

FIG. 8 illustrates, in an aspect, an example timing diagram 860 for NAN discovery beacon transmissions on an uncongested channel. If the channel is not congested, there is a high probability of the scanning devices receiving NAN discovery beacon transmissions without the likelihood of interference and collision. Therefore, the processor 532 of the wireless device 530, such as the AP 304 or the NAN master 406-a, may be configured to increase the interval at which the NAN discovery beacons are transmitted in an uncongested environment, or a clean channel. By increasing the discovery beacon transmission interval, the frequency of the discovery beacon transmissions is decreased. Decreasing the frequency of the discovery beacon transmissions on an uncongested channel may provide a power savings benefit to the scanning devices by limiting a number of wake up cycles.

As shown in the example timing diagram 860, NAN discovery beacons 862 may be transmitted at a second discovery beacon transmission interval 868 when the channel is uncongested. The second discovery beacon transmission interval 868 may be greater than the default discovery beacon transmission interval 664 (FIG. 6). Being a lenient interval, the second discovery beacon transmission interval 868 may have a duration of Z Tus, with Z>X (where X is the duration of the default discovery beacon transmission interval 664).

In addition, the second discovery beacon transmission interval 868 may be greater than the first discovery beacon transmission interval 766 (FIG. 7), with Z>Y (where Y is the duration of the first discovery beacon transmission interval 766). The wireless device 530, such as the AP 304 or the NAN master 406-a, may periodically transmit a NAN discovery beacon 862 once every Z Tus. The second discovery beacon transmission interval 868 may be preprogrammed into a memory associated with a processor of the wireless device, such as the memory 534 associated with the processor 532 of the wireless device 530.

Furthermore, the second discovery beacon transmission interval 868 may be within the range for discovery beacon transmission provided by the NAN Technical Specification. For example, the second discovery beacon transmission interval 868 may be proximate or equal to the upper bound of the range provided by the NAN Technical Specification. However, other configurations for the second discovery beacon transmission interval 868 may be used.

The processor 532 of the wireless device 530, such as the AP 304 or the NAN master 406-a, may be configured to transmit the NAN discovery beacons 862 at the second discovery beacon transmission interval 868 when the channel is uncongested. More specifically, the wireless device 530 may transmit the NAN discovery beacons 862 at the second discovery beacon transmission interval 868 if the congestion score is below the predetermined threshold. However, other configurations may be used to adapt the discovery beacon transmission interval in an uncongested environment.

In addition, it is to be understood that the novel feature of an adaptive discovery beacon transmission interval described herein may have more or less than three discovery beacon transmission intervals (i.e., the default discovery beacon transmission interval 664, the first discovery beacon transmission interval 766, and the second discovery beacon transmission interval 868). For example, rather than having only the default discovery beacon transmission interval 664, the first discovery beacon transmission interval 766, and the second discovery beacon transmission interval 868, the wireless device 530 may have a wide array of discovery beacon transmission intervals that correspond to various congestion levels or congestion scores.

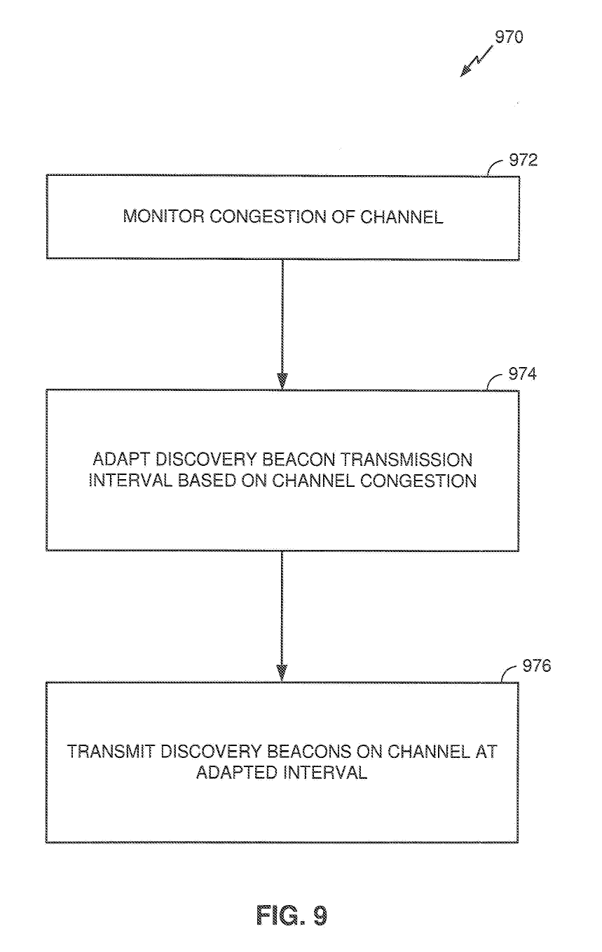

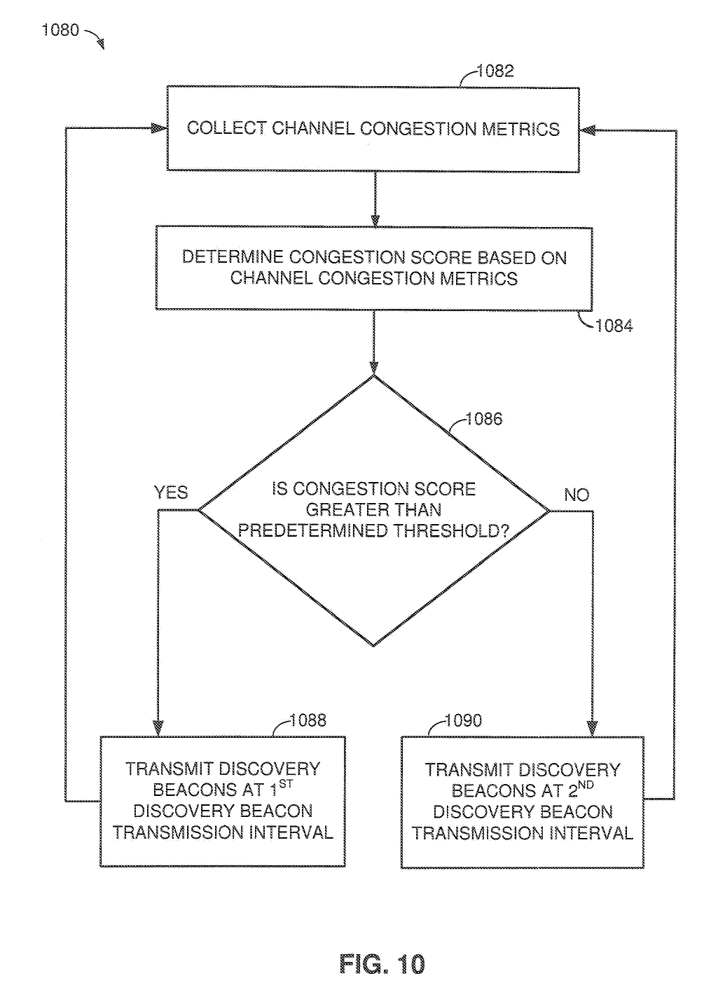

Referring to FIGS. 9 and 10, examples of one or more operations related to the wireless device 530 (FIG. 5) according to the present apparatus and methods are described with reference to one or more methods and one or more components. Although the operations described below are presented in a particular order and/or as being performed by an example component, it should be understood that the ordering of the actions and the components performing the actions may be varied, depending on the implementation. Also, although the wireless device 530 is illustrated as having a number of subcomponents, it should be understood that one or more of the illustrated subcomponents may be separate from, but in communication with, the wireless device 530 and/or each other. Moreover, it should be understood that the following actions or components described with respect to the wireless device 530 and/or its subcomponents may be performed by one or more specially-programmed processors, processors executing specially-programmed software or computer-readable media, or by any other combination of one or more hardware components and/or software components specially configured for performing the described actions or components. For example, various aspects of the operation of the wireless device 530 and/or its subcomponents may be performed by, or implemented in, the processor 532 in FIG. 2.

In FIG. 9, a flowchart is shown illustrating a method 970 for wireless communications that may be employed within the wireless communication systems 100, 200, 300, and 400 of FIGS. 1-4. The method 970 may be implemented in whole or in part by the wireless devices described herein, such as the wireless device 530 shown in FIG. 5. At block 972, the wireless device 530 may monitor a congestion of a channel. For example, the wireless device 530 may monitor the congestion on channel 6 (2.437 GHz) of the 2.4 GHz band, channel 44 (5.220 GHz) or channel 149 (5.745 GHz) of the 5 GHz band. In an aspect, the transmitter 538, the receiver 540, the transceiver 542, the signal detector 546, and/or the processor 532 may monitor the congestion of the channel.

At block 974, the wireless device 530 may adapt an interval at which discovery beacons are transmitted based on the congestion of the channel. For example, the wireless device 530 may increase the interval at which the discovery beacons are transmitted if the channel is congested or may decrease the interval at which the discovery beacons are transmitted if the channel is uncongested. In an aspect, the processor 532 may adapt the interval at which the discovery beacons are transmitted based on the congestion of the channel.

At block 976, the wireless device 530 may transmit the discovery beacons on the channel at the adapted interval. In an aspect, the transmitter 538, the transceiver 542, and/or the processor 532 may transmit the discovery beacons on the channel at the adapted interval.

In FIG. 10, a flowchart is shown illustrating a method 1080 for wireless communications that may be employed within the wireless communication systems 100, 200, 300, and 400 of FIGS. 1-4. The method 1080 may be implemented in whole or in part by the wireless devices described herein, such as the wireless device 530 shown in FIG. 5.

At block 1082, the wireless device 530 may collect at least one channel congestion metric. For example, the wireless device 530 may collect the at least one channel congestion metric when NAN is enabled and the wireless device 530 assumes the role of the master device. The wireless device 530 may transmit discovery beacons at the default discovery beacon transmission interval until the at least one channel congestion metric is collected. In an aspect, the transmitter 538, the receiver 540, the transceiver 542, the signal detector 546, and/or the processor 532 may collect the at least one channel congestion metric.

At block 1084, the wireless device 530 may determine a congestion score based on the at least one channel congestion metric. For example, the congestion score may be proportional to an amount of congestion on the channel. In an aspect, the processor 532 may determine the congestion score based on the at least one channel congestion metric.

At block 1086, the wireless device 530 may determine whether the congestion score is greater than a predetermined threshold. For example, the predetermined threshold may be preprogrammed into the memory 534 associated with the processor 532 and may be established via field testing and laboratory experimentation. In an aspect, the processor 532 may determine whether the congestion score is greater than the predetermined threshold.

At block 1088, the wireless device 530 may transmit the discovery beacons at a first discovery beacon transmission interval if the congestion score is above the predetermined threshold. For example, the first discovery beacon transmission interval may be less than the default discovery beacon transmission interval. In an aspect, the transmitter 538, the transceiver 542, and/or the processor 532 may transmit the discovery beacons at the first discovery beacon transmission interval if the congestion score is above the predetermined threshold.

At block 1090, the wireless device 530 may transmit the discovery beacons at a second discovery beacon transmission interval if the congestion score is below the predetermined threshold. For example, the second discovery beacon transmission interval may be greater than each of the default discovery beacon transmission interval and the first discovery beacon transmission interval. In an aspect, the transmitter 538, the transceiver 542, and/or the processor 532 may transmit the discovery beacons at the second discovery beacon transmission interval if the congestion score is below the predetermined threshold.

The various operations of methods described above may be performed by any suitable means capable of performing the operations, such as various hardware or software component(s), circuits, or component(s). Generally, any operations illustrated in the Figures may be performed by corresponding functional means capable of performing the operations.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, flash memory, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Accordingly, an aspect of the disclosure can include a non-transitory computer-readable storage medium embodying a method for wireless communications. Accordingly, the disclosure is not limited to the illustrated examples.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method for wireless communications, comprising:
monitoring, at a wireless device, a congestion of a channel;
adapting, at the wireless device, an interval at which discovery beacons are transmitted based on the congestion of the channel; and
transmitting from the wireless device the discovery beacons on the channel at the adapted interval.

2. The method of claim 1, further comprising decreasing the interval at which the discovery beacons are transmitted if the channel is congested.

3. The method of claim 1, further comprising increasing the interval at which the discovery beacons are transmitted if the channel is uncongested.

4. The method of claim 1, further comprising collecting at least one channel congestion metric.

5. The method of claim 4, further comprising determining a congestion score based on the at least one channel congestion metric.

6. The method of claim 5, wherein the congestion score is proportional to an amount of congestion on the channel.

7. The method of claim 5, further comprising transmitting the discovery beacons at a first discovery beacon transmission interval if the congestion score is above a predetermined threshold.

8. The method of claim 7, further comprising transmitting the discovery beacons at a second discovery beacon transmission interval if the congestion score is below the predetermined threshold, the second discovery beacon transmission interval being greater than the first discovery beacon transmission interval.

9. The method of claim 8, wherein the first discovery beacon transmission interval is less than a default discovery beacon transmission interval, and wherein the second discovery beacon transmission interval is greater than the default discovery beacon transmission interval.

10. The method of claim 9, wherein the first discovery beacon transmission interval is proximate a lower bound of a range for discovery beacon transmission provided by a Wi-Fi Neighbor Aware Network (NAN) Technical Specification.

11. The method of claim 10, wherein the second discovery beacon transmission interval is proximate an upper bound of the range for discovery beacon transmission provided by the Wi-Fi NAN Technical Specification.

12. The method of claim 11, further comprising transmitting the discovery beacons at the default discovery beacon transmission interval until the at least one channel congestion metric is collected.

13. The method of claim 12, further comprising collecting data for the at least one channel congestion metric over a plurality of time periods to build a database.

14. The method of claim 13, further comprising using the database to determine the interval at which the discovery beacons are transmitted.

15. A wireless device, comprising:
a transceiver;
a memory; and
a processor communicatively coupled to the transceiver and the memory, the processor configured to:
monitor a congestion of a channel,
adapt an interval at which discovery beacons are transmitted based on the congestion of the channel, and
transmit, via the transceiver, the discovery beacons on the channel at the adapted interval.

16. The wireless device of claim 15, wherein the processor is further configured to decrease the interval at which the discovery beacons are transmitted if the channel is congested.

17. The wireless device of claim 15, wherein the processor is further configured to increase the interval at which the discovery beacons are transmitted if the channel is uncongested.

18. The wireless device of claim 15, wherein the processor is further configured to collect at least one channel congestion metric.

19. The wireless device of claim 18, wherein the processor is further configured to determine a congestion score based on the at least one channel congestion metric.

20. The wireless device of claim 19, wherein the congestion score is proportional to an amount of congestion on the channel.

21. The wireless device of claim 19, wherein the processor is further configured to transmit the discovery beacons at a first discovery beacon transmission interval if the congestion score is above a predetermined threshold.

22. The wireless device of claim 21, wherein the processor is further configured to transmit the discovery beacons at a second discovery beacon transmission interval if the congestion score is below the predetermined threshold, the second discovery beacon transmission interval being greater than the first discovery beacon transmission interval.

23. The wireless device of claim 22, wherein the first discovery beacon transmission interval is less than a default discovery beacon transmission interval, and wherein the second discovery beacon transmission interval is greater than the default discovery beacon transmission interval.

24. The wireless device of claim 23, wherein the first discovery beacon transmission interval is proximate a lower bound of a range for discovery beacon transmission provided by a Wi-Fi Neighbor Aware Network (NAN) Technical Specification.

25. The wireless device of claim 24, wherein the second discovery beacon transmission interval is proximate an upper bound of the range for discovery beacon transmission provided by the Wi-Fi NAN Technical Specification.

26. The wireless device of claim 25, wherein the processor is further configured to transmit the discovery beacons at the default discovery beacon transmission interval until the at least one channel congestion metric is collected.

27. The wireless device of claim 26, wherein the processor is further configured to collect data for the at least one channel congestion metric over a plurality of time periods to build a database.

28. The wireless device of claim 27, wherein the processor is further configured to use the database to determine the interval at which the discovery beacons are transmitted.

29. An apparatus for wireless communication, comprising:
means for monitoring a congestion of a channel;
means for adapting an interval at which discovery beacons are transmitted based on the congestion of the channel; and
means for transmitting the discovery beacons on the channel at the adapted interval.

30. A non-transitory computer-readable storage medium storing instructions that, when executed by one or more processors of a wireless communications device, cause the wireless communications device to:
monitor a congestion of a channel,
adapt an interval at which discovery beacons are transmitted based on the congestion of the channel, and
transmit the discovery beacons on the channel at the adapted interval.
